(19) United States
(12) Patent Application Publication
(10) Pub. No.: US 2023/0398547 A1
(43) Pub. Date: Dec. 14, 2023

(54) MICROPLATE SYSTEM AND CONTAINMENT

(71) Applicant: HOFFMANN-LA ROCHE INC., Little Falls, NJ (US)

(72) Inventors: Sven BURRI, Basel (CH); Rolf CANESSO, Basel (CH); Pascal Markus HOFER, Basel (CH); Jonas LUZIO, Basel (CH); Dieter SCHMIDLI, Basel (CH); Thomas ZUMSTEIN, Basel (CH)

(21) Appl. No.: 18/250,300

(22) PCT Filed: Oct. 28, 2021
(86) PCT No.: PCT/EP21/79994

§ 371 Date: Apr. 24, 2023

(30) Foreign Application Priority Data
Oct. 30, 2020 (EP) 20204979.7

(51) Int. Cl. B01L 9/06; B01L 3/00

(52) U.S. Cl. CPC B01L 9/06; B01L 3/50825; B01L 2200/025; B01L 2300/042; B01L 2300/0832; B01L 2300/0829; B01L 2200/0689; B01L 2300/123

(57) ABSTRACT

A microplate system (1) comprising a microplate (2) and a plurality of containments (3). The microplate (2) has a length in a range between about 127 mm and about 129 mm and a width in a range between about 84 mm and about 86 mm. The microplate (2) has 384 or 1536 receptacles (21). Each receptacle (21) of the microplate (2) extends through the microplate (2) such that it has a first open end and a second open end. Each receptacle (21) of the microplate (2) forms a seat to hold one of the plurality of containments (3). Each of the plurality of containments (3) comprises a cap (32) and a tube (31) shaped to be held in the seat of one of the receptacles (21) of the microplate (2). The plurality of containments (3) and the receptacles (21) of the microplate (2) are shaped such that, in order to be arranged in the microplate (2), each of the plurality of containments (3) is introducible through the first open end of the one of the receptacles (21) into the one of the receptacles (21) until it is held in the seat (212) of the one of the receptacles (21). The tube (31) and the cap (32) of each of the containments (3) are configured to be multiply connected to each other and disconnected from each other.

### TECHNICAL FIELD

The present invention relates to a microplate system according to the preamble of independent claim 1 and more particularly to a containment for such a microplate system.

### BACKGROUND ART

In chemical, microbiological and pharmaceutical industry, as well as in chemical, microbiological and pharmaceutical research, standardized microplates are commonly used. In particular, microplate standards developed by the Society for Biomolecular Screening (SBS), the successor organization of which is the Society for Laboratory Automation and Screening (SLAS), and approved by the American National Standards Institute (ANSI) define microplates of 127.76 mm length, 85.48 mm width and 14.35 mm typical height comprising 96, 384 or 1536 wells or receptacles. The wells or receptacles of such standardized microplates usually have a circular or square shaped cross-section and a flat, rounded or pyramidal, symmetrical bottom.

In use of microplates with receptacles, containments such as appropriately dimensioned tubes can be filled with fluids, such as chemical or microbiological assays comprising several components. In order to establish homogenous conditions, frequently said fluids are mixed in the containments. The tubes can be made of glass, plastic or another suitable material and may be, for example, test tubes, microcentrifuge tubes, capillary tubes, storage tubes, library reformatting tubes, or the like.

Standardized microplates can particularly be beneficial as they allow for using equipment adapted or configured in accordance with the respective standards. For example, it is possible to use robotic arrangements in many applications of microplates. Thereby, not only the defined size and location of the receptacles but also, e.g., cut away corners in accordance with the standards enable an error-free positioning or orientation of the microplates. Particularly, when it is desired to involve microplates in automated processes or automated process steps such standardized microplates are beneficial.

In this connection, to improve handling of the tubes involved process in microplates the receptacles have been further developed to facilitate transfer of the tubes, e.g., from one microplate to another. Thereby, the microplates may allow for arranging the tubes into the microplate from one side thereof and removing the tubes from an opposite side thereof. More specifically, it is known to configure the receptacle to extend through the microplate such that the comprise open ends at both sides of the microplate, wherein in between a seat is formed to hold the respective tube.

For protecting substances or sample inside of tubes for standardized microplates, it is known to seal the open ends of the tube with a foil or a similar structure. For accessing the substance or sample inside a tube the foil is teared off the tube or pierced such that its interior is accessible.

In particular, when comparably small tubes such as tubes for microplates with 384 or 1536 receptacles are involved, sealing or closing and opening of the tubes is comparably difficult. Usually, the tubes and the foils typically are disposed after being used or processed.

Therefore, there is a need for a microplate system or a containment for a microplate allowing an improved processing when standardized microplates having 384 or 1536 receptacles are involved.

### DISCLOSURE OF THE INVENTION

According to the invention this need is settled by a microplate system as it is defined by the features of independent claim 1, and by a containment as it is defined by the features of independent claim 15. Preferred embodiments are subject of the dependent claims.

In one aspect, the invention is a microplate system comprising a microplate and a plurality of containments. The microplate has a predefined length and a predefined width. More specifically, the length is in a range between about 127 mm and about 129 mm, between about 127.3 mm and about 128.3 mm or between 127.26 mm and 128.26 mm, or of about 127.76 mm. The width is in a range between about 84 mm and about 86 mm, between about 84.9 mm and about 86 mm or between 84.98 mm and 85.98 mm, or of about 85.48 mm.

The microplate has 384 or 1536 receptacles, wherein each receptacle extends through the microplate such that it has a first open end and a second open end. Further, each receptacle of the microplate forms a seat to hold one of the plurality of containments. Each of the plurality of containments comprises a cap and a tube shaped to be held in the seat of one of the receptacles of the microplate.

The plurality of containments and the receptacles of the microplate are shaped or configured such that, in order to be arranged in the microplate, each of the plurality of containments is introducible through the first open end of the one of the receptacles into the one of the receptacles until it is held in the seat of the one of the receptacles. The tube and the cap of each of the containments are configured to be multiply connected to each other and disconnected from each other.

The microplate can particularly be configured to meet microplates standards of the American National Standards Institute (ANSI) and the Society for Laboratory Automation and Screening (SLAS), i.e. ANSI/SLAS 1-2004: Microplates—Footprint Dimensions; ANSI/SLAS 3-2004: Microplates—Bottom Outside Flange Dimensions; and ANSI/SLAS 4-2004: Microplates—Well Positions. For example, when being equipped with 384 receptacles, the receptacles can be regularly arranged in sixteen rows of twenty-four receptacles.

By configuring the receptacles to extend through the microplate such that they have first and second open ends it can be achieved that the containments can efficiently be processed in or to the microplate, i.e. they can be processed at both sides of the microplates via the first or second ends of the receptacles as desired. Preferably, the plurality of containments and the receptacles of the microplate are shaped such that, in order to be removed from the microplate, each of the plurality of containments is pushable through the microplate out of the seat of the one of the receptacles through the second open end of the one of the receptacles. By means of such a push through embodiment, it can be efficient to automatically arrange the containments into the microplate from one side and to remove them at the other side.

The tube of the containments can have an essentially cylindrical body portion with a hollow interior and an open end. The open end can be embodied to access the interior of the tube. The end opposite the open end can be permanently closed or it can be equipped with an outlet such as a spout or the like. The outlet can be tightly sealed with a removable or permanently fixed closure. The tube can particularly be embodied to receive and house a substance such as drug or pharmaceutical substance, a chemical compound, a research substance, or a similar composition. The substance can be intended to be used in a in vitro assay or in an in vivo assay, in which, e.g., determination of the physical properties of the substance may be required.

The term “drug” as used herein relates to a therapeutically active agent, also commonly called active pharmaceutical ingredient (API), as well as to a combination of plural such therapeutically active substances. The term also encompasses diagnostic or imaging agents, like for example contrast agents (e.g. MRI contrast agents), tracers (e.g. PET tracers) and hormones, that need to be administered in liquid form to the patient.

The term “drug substance”, “pharmaceutical substance” or “pharmaceutical” as used herein relates to a drug as defined above formulated or reconstituted in a form that is suitable for administration to the patient. For example, besides the drug, a drug substance may additionally comprise an excipient and/or other auxiliary ingredients. A particularly preferred drug substance in the context of the invention is a drug solution, in particular a solution for oral administration, injection or infusion.

The term “drug product” as used herein or similar relates to a finished end product comprising a drug substance or a plurality of drug substances. In particular, a drug product may be a ready to use product having the drug substance in an appropriate dosage and/or in an appropriate form for administration. For example, a drug product may include the containment or an administration device such as a prefilled syringe or the like.

The term “cap” as used herein relates to any closure or cover suitable to close the tube with an appropriate tightness.

By the tube and the cap of each of the containments being configured to be multiply connected to each other and disconnected from each other it can be achieved that the tube can be accessed multiple times independent from each other. This allows for an efficient multi step processing of a substance inside the tube. Or, it allows to re-use the tube and to prevent disposal thereof such that multiple usage of the tube and cap is possible. Particularly, containments at small dimensions which are more difficult to handle compared to larger containments can be efficiently processed when being equipped with a sophisticated cap and tube closure system. Thus, the microplate system according to the invention allows for an improved process involving standardized microplates having 384 or 1536 receptacles.

The cap can be connected to and disconnected from the tube in various distinct ways. In particular, the cap and the tube can be specifically embodied to allow an efficient mounting for connecting and de-mounting for disconnecting. Thereby, advantageously such mounting and de-mounting makes it possible that the containment is automatically processed, e.g., by means of a robotic device or the like. At the same time, it may guarantee a sufficiently tight closing of the tube to prevent contamination or spillage of the substance inside the tube.

In one preferred embodiment, the cap of each containment comprises a first thread structure and the tube of each containment comprises a second thread structure corresponding to the first thread structure of the cap. Such thread structures allow for an efficient automatized implementation of mounting and de-mounting the cap as well as a tight closing of the tube. For example, such thread structures allow for simply screwing the cap onto or off the tube.

Thereby, preferably, the tube has an open end, the cap has a stem section configured to be provided into the open end of the tube, the first thread structure is arranged at an outer boundary of the stem section of the cap, the second thread structure is arranged at an inner boundary of the tube and the first thread structure engages the second thread structure when the cap is connected to the tube. By such arrangement the cap can be screwed onto the tube such that the open end of the tube can be efficiently closed in a reversible manner. Thereby, the cap of the tube can be equipped with a gasket or similar sealing part to be clamped between cap and the tube. Such gasket part allows for providing a particularly tight closing of the tube. Such tight closing can prevent contamination of the interior of the tube and spillage out of the interior of the tube.

Preferably, the seat of each receptacle of the microplate has a first mating formation, the tube of each containment has a second mating formation and the first mating formation of the seat of the receptacle cooperates with the second mating formation of the tube when the tube is arranged in the seat of the receptacle such that rotation of the tube relative to the microplate is prevented. The term “rotation” in this context can particularly relate to a rotation about a longitudinal axis of the tube. Such arrangement of tube and receptacle allows for mounting the cap onto the tube as well as de-mounting the cap from the tube by a screwing-like motion without holding the tube in addition to being arranged in the seat of the receptacle. In other words, when being arranged in the receptacle, the mating formations allow to simply screwing the cap onto and off the tube by exclusively moving/holding the cap.

Thereby, the second mating formation of the tube preferably comprises a protrusion and the first mating formation of the seat of the receptacle comprises a corresponding indentation configured to receive the protrusion of the second mating formation of the tube when the tube is arranged in the seat of the receptacle. By such protrusion and a corresponding indentation, rotation of the tube can be prevented by means of a comparably simple construction. The protrusion can particularly extend from an outer boundary of the tube. For example, it can be shaped in a wing-like fashion radially extending from the tube or a body thereof. The indentation corresponds to the protrusion in such a way that protrusion and indentation can interact to block a rotation of the tube inside the receptacle. Thereby, it is not necessary that protrusion and indentation do have the same shape but it is sufficient if they mate to an extent such that rotation is sufficiently prevented in order that mounting and de-mounting of the cap is possible without additionally holding the tube. Advantageously, the tube is provided with a plurality of protrusions. Like this, the tube can more stably be held in the receptacle and rotation when mounting or de-mounting the cap can efficiently be prevented.

In another preferred embodiment, the cap of each of the containments comprises a first press-fit structure and the tube of each of the containments comprises a second press-fit structure corresponding to the first press-fit structure of the cap.

The term “press-fit” as used in this connection relates to an interference fit or friction fit being a form of fastening between tight fitting mating parts, i.e. the cap and the tube, that produces a joint which is held together by friction, particularly after the parts are pushed together. The first and second press-fit structures can involve an elastic portion, e.g., of the cap and a rigid portion, e.g. of the tube, which are abutting when the cap is connected to the tube.

By providing the cap and the tube with corresponding press-fit structures, the cap can efficiently be mounted or connected to the tube by being pushed into the tube or the like. Likewise, it can efficiently be de-mounted or removed from the tube by being pulled out of the tube. In particular, such pushing and pulling can be provided along the longitudinal axis of the tube.

Thereby, the first press-fit structure of the cap preferably is pressed against the second press-fit structure of the tube, when the cap and the tube are connected. By means of such pressing the friction forces applied can be sufficient to securely hold the cap in the tube. For example, such pressing can be achieved by providing either one of the cap or the tube, or even a section thereof, of an elastically deformable material.

The first press-fit structure of the cap preferably comprises a sealing bulge at an outer circumference of the cap. Such sealing bulge can, e.g., provide elasticity to be deformed when the cap is connected to the tube. By means of such a sealing bulge, the tube can be tightly closed such that the interior of the tube can be safely sealed.

Thereby, the cap preferably comprises a snap cavity with an opening accessible when the cap is connected to the tube. Such snap cavity allows for efficiently handling the cap. In particular, the snap cavity allows that a tool snaps into the cap and moves or otherwise handles the cap. For example, the cap can be snapped on the tool and forwarded by the tool into the respective tube, which is arranged in one of the receptacles of the microplate.

In an alternative embodiment, the cap of each of the containments comprises a first snap-fit structure and the tube of each of the containments comprises a second snap-fit structure corresponding to the first snap-fit structure of the cap. By providing the cap and the tube with corresponding snap-fit structures, the cap can efficiently be mounted or connected to the tube by being pushed onto the tube. Likewise, it can efficiently be de-mounted or removed from the tube by being pulled off the tube. In particular, such pushing and pulling can be provided along the longitudinal axis of the tube.

Thereby, the first snap-fit structure of the cap preferably engages the second snap-fit structure of the tube, when the cap and the tube are connected. The first snap-fit structure of the cap preferably comprises a rim at an inner circumference. The inner circumference can particularly be at an inner boundary of the cavity of the cap. The rim can extend along the inner circumference wherein it advantageously is continuous along the entire inner circumference. The second snap-fit structure of the tube preferably comprises a groove at an outer circumference. The outer circumference can particularly be at an outer boundary of the tube. Specifically, the groove can extend around the tube wherein it advantageously is continuous about the entire outer circumference.

In any of the above preferred embodiments, the cap of each of the containments is preferably made of a comparably elastically deformable material and the tube of each of the containments is preferably made of a comparably rigid material. The terms “comparably elastically deformable” and comparably rigid” relates to properties of the materials of the tube and the cap relative to each other. More specifically, the material of the cap is comparably elastically deformable by being more elastically deformable as the material of the tube. Likewise, the material of the tube is comparably rigid by being more rigid than the material of the cap. By such materials it can efficiently be achieved that the tube is tightly closed by the cap.

Particularly when the cap and the tube have press-fit structures, preferably, the cap has an outer diameter, the tube has an inner diameter and the inner diameter of the tube is smaller than the outer diameter of the cap. In such configuration, it can be assured that a pressing is achieved between tube and cap such that the cap can be safely held by friction.

Alternatively or additionally, the cap or a section thereof can be provided with a slip agent. Such slip agent may allow a more convenient or efficient closing of the tube in some applications, e.g. not requiring particular resistance such as dimethyl sulfoxide or similar solvent resistance. For example, friction when advancing the cap into or onto the tube may be reduced by the slip agent.

The tube preferably has an open end and the cap preferably is configured to be at least partially compressed when being forwarded into the tube through the open end of the tube. Such compression allows for tightly closing of the tube. Additionally, the cap can be safely held when being advanced into the tube.

Preferably, the tube has an inner periphery equipped with a protrusion. Such protrusion allows for predefining an extent of introducing the cap into the tube. Further, it may increase resistance when inserting the cap.

When the cap and the tube have snap-fit structures, the cap can have an inner diameter, the tube an outer diameter and the inner diameter of the cap can be smaller than the outer diameter of the tube. The inner diameter of the cap can particularly be a diameter of the cavity of the cap. By having at least slightly different inner and outer diameters the cap is deformed or tensioned when being mounted to the tube. Like this, a tight closing can efficiently be achieved. Particularly, when being equipped with snap-fit structures such dimensioning can be appropriate for generating tightness.

Thereby, the tube can have an open end, the cap an opened cavity configured to receive the open end of the tube, and the opened cavity can have the inner diameter and a tapering entrance, e.g. towards the inner diameter. By having such tapering entrance, the cap can efficiently correctly position such as centred relative to the tube for being mounted thereto. Particularly, when comparably small tubes are involved such positioning may be beneficial.

In another aspect, the invention is a containment configured to be held in a seat of one of 384 or 1536 receptacles of a microplate which has a length in a range between about 127 mm and about 129 mm, between about 127.3 mm and about 128.3 mm or between 127.26 mm and 128.26 mm, or of about 127.76 mm, and a width in a range between about 84 mm and about 86 mm, between about 84.9 mm and about 86 mm or between 84.98 mm and 85.98 mm, or of about 85.48 mm, wherein each receptacle extends through the microplate such that it has a first open end and a second open end, and forms the seat, and shaped such that, in order to be arranged in the microplate, the containments is introducible through the first open end of the one of the receptacles until it is held in the seat of the one of the receptacles and, in order to be removed from the microplate, is pushable through the microplate out of the seat of the one of the receptacles through the second open end of the one of the receptacles. The containment comprises a tube and a cap, wherein the tube is shaped to be held in the seat, and the tube and the cap are configured to be multiply connected to and disconnected from each other.

By the containment according to the invention and its preferred embodiments described below the effects and benefits of the microplate system and its preferred embodiments described above can likewise be implemented. The containment according to the invention can particularly be a containment of a microplate system as described above.

The cap of the containment preferably comprises a first thread structure and the tube preferably comprises a second thread structure corresponding to the first thread structure of the cap. Thereby, preferably the tube has an open end, the cap has an opened cavity configured to receive the open end of the tube, the first thread structure is arranged at an inner boundary of the opened cavity of the cap, the second thread structure is arranged at an outer boundary of the tube and the first thread structure engages the second thread structure when the cap is connected to the tube such that the opened cavity of the cap receives the open end of the tube.

Preferably, the tube of the containment has a second mating formation, corresponding to a first mating formation of the seat of a receptacle of the microplate, wherein the first mating formation of the seat of the receptacle cooperates with the second mating formation of the tube when the tube is arranged in the seat of the receptacle such that rotation of the tube relative to the microplate is prevented which may particularly relevant of the cap is screwed into the tube. Thereby, the second mating formation of the tube preferably comprises a protrusion.

Preferably, the cap of each of the containments comprises a first press-fit structure and the tube of each of the containments comprises a second press-fit structure corresponding to the first press-fit structure of the cap. Thereby, the first press-fit structure of the cap preferably is pressed against the second press-fit structure of the tube, when the cap and the tube are connected.

The first press-fit structure of the cap preferably comprises a sealing bulge at an outer circumference of the cap. Thereby, the cap preferably comprises a snap cavity with an opening accessible when the cap is connected to the tube.

The cap of the containment preferably is made of a comparably elastically deformable material and the tube of the containment preferably is made of a comparably rigid material. Preferably, the cap has an outer diameter, the tube has an inner diameter and the inner diameter of the tube is smaller than the outer diameter of the cap. The tube preferably has an open end and the cap preferably is configured to be at least partially compressed when being forwarded into the tube through the open end of the tube. Preferably, the tube has an inner periphery equipped with a protrusion.

In an advantageous embodiment the cap and/or the tube are provided with an identification code. Such code may be indicative for the type of cap or tube. Also, it may contain other information useful in application of the system. For example, the identification code is embodied as bar code or as QR-code.

### BRIEF DESCRIPTION OF THE DRAWINGS

The microplate system according to the invention and the containment according to the invention are described in more detail hereinbelow by way of an exemplary embodiment and with reference to the attached drawings, in which:

FIG. 1 shows a first embodiment of a microplate system according to the invention comprising a plurality of a first embodiment of a containment according to the invention and a microplate;

FIG. 2 shows a top view on a tube of one of the containments of the microplate system of FIG. 1;

FIG. 3 shows a cross sectional view the tube of the containment of the microplate system of FIG. 1 along the line C-C of FIG. 2;

FIG. 4 shows a side view of a cap of one of the containments of the microplate system of FIG. 1;

FIG. 5 shows a second embodiment of a microplate system according to the invention comprising a plurality of a second embodiment of a containment according to the invention and the microplate of FIG. 1;

FIG. 6 shows a top view on a tube of one of the containments of the microplate system of FIG. 5;

FIG. 7 shows a cross sectional view the tube of the containment of the microplate system of FIG. 5;

FIG. 8 shows a cross sectional view of a cap of one of the containments of the microplate system of FIG. 5;

FIG. 9 shows a top view on the microplate of FIG. 1 and of FIG. 5; and

FIG. 10 shows cross sectional view of the microplate along the line A-A of FIG. 9.

### DESCRIPTION OF EMBODIMENTS

In the following description certain terms are used for reasons of convenience and are not intended to limit the invention. The terms “right”, “left”, “up”, “down”, “under” and “above” refer to directions in the figures. The terminology comprises the explicitly mentioned terms as well as their derivations and terms with a similar meaning. Also, spatially relative terms, such as “beneath”, “below”, “lower”, “above”, “upper”, “proximal”, “distal”, and the like, may be used to describe one element's or feature's relationship to another element or feature as illustrated in the figures. These spatially relative terms are intended to encompass different positions and orientations of the devices in use or operation in addition to the position and orientation shown in the figures. For example, if a device in the figures is turned over, elements described as “below” or “beneath” other elements or features would then be “above” or “over” the other elements or features. Thus, the exemplary term “below” can encompass both positions and orientations of above and below. The devices may be otherwise oriented (rotated 90 degrees or at other orientations), and the spatially relative descriptors used herein interpreted accordingly. Likewise, descriptions of movement along and around various axes include various special device positions and orientations.

To avoid repetition in the figures and the descriptions of the various aspects and illustrative embodiments, it should be understood that many features are common to many aspects and embodiments. Omission of an aspect from a description or figure does not imply that the aspect is missing from embodiments that incorporate that aspect. Instead, the aspect may have been omitted for clarity and to avoid prolix description. In this context, the following applies to the rest of this description: If, in order to clarify the drawings, a figure contains reference signs which are not explained in the directly associated part of the description, then it is referred to previous or following description sections. Further, for reason of lucidity, if in a drawing not all features of a part are provided with reference signs it is referred to other drawings showing the same part. Like numbers in two or more figures represent the same or similar elements.

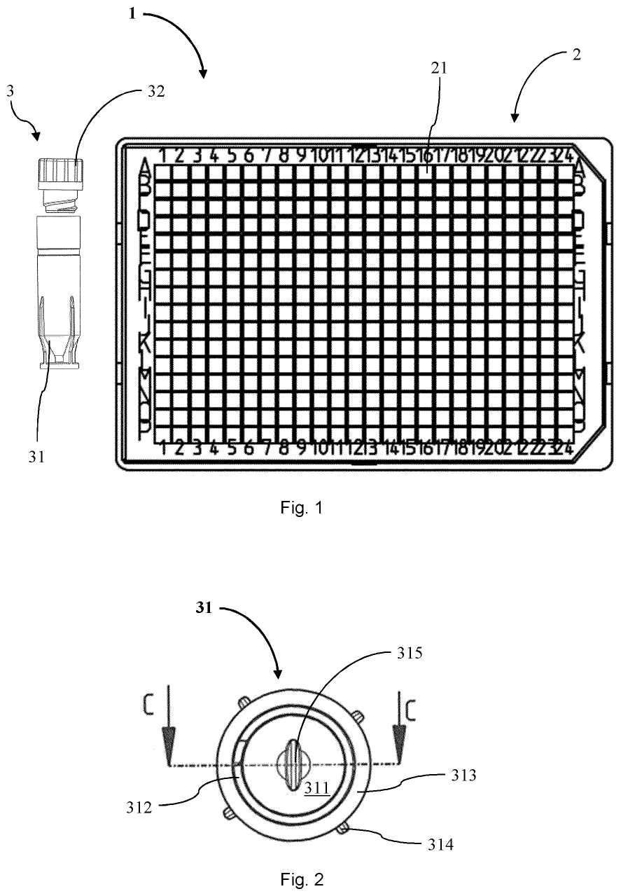

FIG. 1 shows a first embodiment of a microplate system 1 according to the invention comprising a microplate 2 and a plurality of first embodiments of containments 3 according to the invention. The microplate 2 comprises plural receptacles 21 for receiving the containments 3. In the FIGS. one single containment 3 is exemplarily depicted, wherein the microplate system has a number of identical containments 3. Each of the containments 3 comprises a tube 31 and a cap 32.

In FIG. 2 the tube 31 of one of the containments 3 is shown. Thereby, it can be seen that the tube 31 has an essentially cylindrical hollow body 313 with an upper open end 311, at a lower end the body 313 is embodied with an access geometry 315. From a periphery of the body 313 four wing-like protrusions 314 radially extend as second mating formation. The protrusions 314 are at a right angle to each other and are arranged along a lower portion of the body 313. At an inner side of the body 313 a thread 312 of a second thread structure inwardly extends from the body 313.

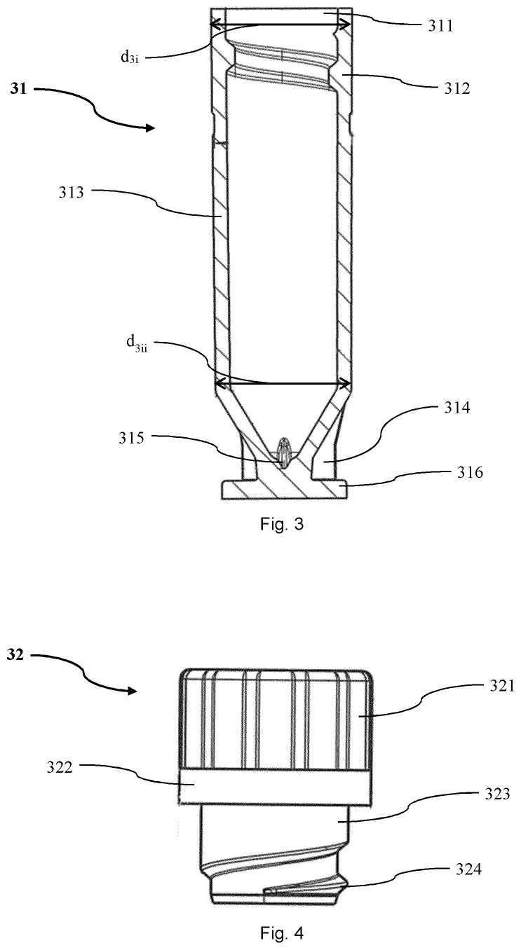

FIG. 3 cross sectionally shows the tube 31. The body 313 has a wall wherein the thread 312 inwardly extends from the wall near the open end 311. Further, the body 313 slightly tapers form the open end 311 towards the access geometry 315 such that an outer diameter d₃ᵢ of the tube 31 at the open end 311 is larger than an outer diameter d₃ᵢᵢ of the tube 31 near the access geometry 315.

The access geometry 315 comprises a conical portion passing over into the body 313 at its upper end and downwardly tapering. At a lower end the access geometry 315 is equipped with a rounded portion. The shape of the access geometry 315 allows on the one hand that any substance inside the tube 31 is gathered in a tip like structure and on the other hand that the substance can be more or less completely accessed, e.g., by a pipetting tube. The lower end of the tube 31 is formed by a foot section 316 shaped such that the tube 31 can be upwardly placed on an essentially horizontal surface.

The tube 31 is made of a comparably rigid material such as polypropylene or a similar material.

In FIG. 4 the cap 32 is shown in more detail. Thereby, it can be seen that the cap 32 is a two-component construction having a main part and a gasket part 322. The main part has a head 321 and a stem 323 downwardly extending from the head 321. The head 321 is equipped with a driver socket (not visible in FIG. 4) accessible to a suitable driver tool top down. The gasket part 322 is a flat seal arranged about the stem 323 and abutting the head 321. Alternatively, the gasket part can also be embodied as lip seal or the like. Towards its lower end, the stem 323 is equipped with an outer thread 324 as first thread structure.

In use of the containment 3 a substance is arranged in the interior of the tube 31. The cap 32 is connected or mounted to the tube 31 by providing the stem 323 into the open end 311. The outer thread 324 of the stem 323 engages the inner thread 312 of the tube 31 and the cap 32 is screwed onto the tube 31. The gasket part 322 is made of a comparably soft and elastic material which allows to be compressed when the cap 32 is screwed onto the tube 31. Like this, the open end 311 of the tube 31 is tightly closed.

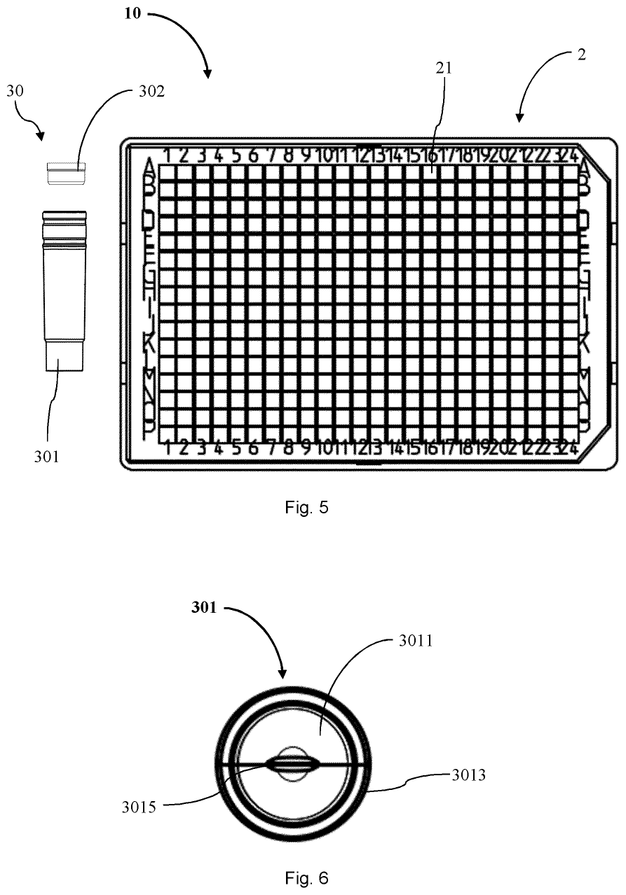

FIG. 5 shows a second embodiment of a microplate system 10 according to the invention comprising the identical microplate 2 as the first embodiment described above and a plurality of second embodiments of containments 30 according to the invention. Each of the containments 30 comprises a tube 301 and a cap 302.

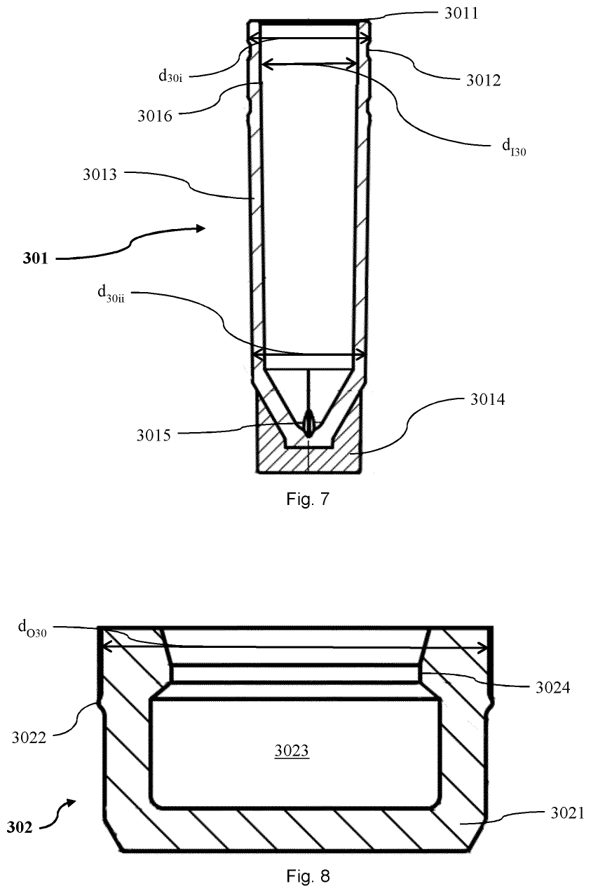

In FIG. 6 the tube 301 of one of the containments 30 is shown from above, i.e. towards an open end 3011 thereof. The tube 301 has an essentially cylindrical hollow body 3013 with the upper open end 3011. At a lower end the body 3013 is equipped with an access geometry 3015. As can be seen in the cross-sectional view of the tube 301 of FIG. 7, the body 3013 has a wall which is equipped with two axially distant grooves 3012 as second press-fit structure. The grooves 3012 extend about an outer circumference or periphery of the body 3013 and are located near the open end 3011. The grooves 3012 allow for holding the tube 301 in two different axial positions in a seat of one of the receptacles 21 of the microplate 2.

The body 3013 of the tube 301 slightly tapers from the open end 3011 towards the access geometry 3015 such that an outer diameter d₃₀ᵢ of the tube 301 at the open end 3011 is larger than an outer diameter d₃₀ᵢᵢ of the tube 301 near the access geometry 3015. An interior of the tube 301 defines an inner periphery of the tube 301 having an inner diameter d_{I30} close the open end 3011. Further, a circumferential protrusion 3016 is extends about the inner periphery of the tube 301.

The access geometry 3015 comprises a conical portion passing over into the body 3013 at its upper end and tapering in a downward direction. At a lower end the outlet 3015 is equipped with a rounded portion. Downwardly, the tube ends in a foot 3014. The tube 301 is made of a comparably rigid material such as polypropylene or a similar material.

FIG. 8 shows the cap 302 of the containment 30 in a cross-sectional view. Thereby, it can be seen that the cap 302 has an upwardly opened snap-fit cavity 3023. The snap-fit cavity 3023 is configured to receive a tool for handling the cap 302, wherein at an inner boundary of the snap-fit cavity 3023, a circumferential rim 3024 is arranged as snap-fit or first press fit structure. The cap 302 is made of a comparably elastically deformable material and has an outer diameter dom.

To connect the cap 302 to the tube 301 it is pressed top down into the open end 3011 of the tube 3011. Thereby, the protrusion 3016 of the tube 301 provides additional resistance. The outer diameter don of the cap 302 is slightly larger than the inner diameter d_{I30} of the tube 301. Like this, it is achieved that the cap 302 is compressed when being pushed into the tube such that the cap 302 and the tube 301 are press-fitted.

Furthermore, an outer periphery of the cap 302 is equipped with a circumferential protrusion 3022 as sealing bulge. When being pushed into the tube 301, the protrusion 3022 is additionally deformed such that a tight connection of cap 302 and tube 301 is achieved. Thereby, a seal closing of the interior of the tube 301 is generated.

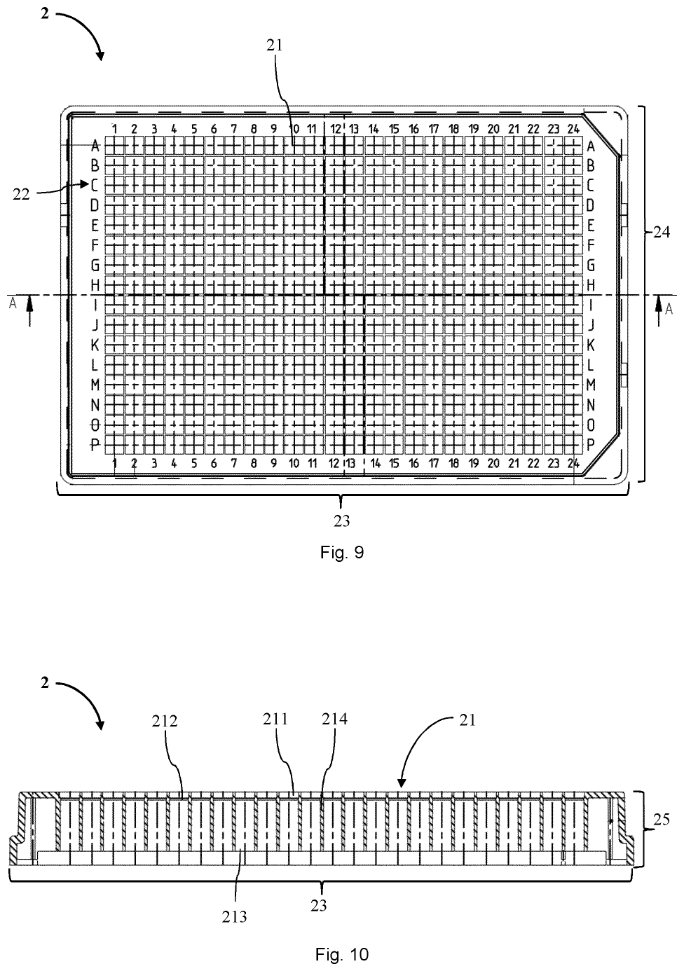

In FIG. 9 a top view on the microplate 2 of the first and second embodiments of the microplate system 1, 10 according to the invention is shown. The microplate 2 has sixteen rows 22 of twenty-four receptacles 21. The receptacles 21 have a squared cross-section. The microplate 21 is dimensioned in accordance with the standards ANSI/SLAS 1-2004: Microplates—Footprint Dimensions, ANSI/SLAS 3-2004: Microplates—Bottom Outside Flange Dimensions, and ANSI/SLAS 4-2004: Microplates—Well Positions. Thereby, the microplate has a length 23 of 127.76 mm, a width of 85.48 mm and as depicted in the cross-sectional view of FIG. 10 a height of 14.35 mm. Depending on type of tubes and caps used, the height may vary.

FIG. 10 further shows that each receptacle 21 is formed by four vertically extending side walls 214. Thereby, each receptacle 21 extends through the microplate 2 such that it has a top first open end 211 and a bottom second open end 213. Near the first open end 211 an inwardly extending seat rim 212 is provided as seat along the inner circumference of the receptacle. More specifically, whereas the distance between the side walls 214 generally is slightly larger than the outer diameter d₃ᵢ, d₃₀ᵢ of the respective tube 31, 301 at its open end 311, 3011, at the seat rim 212 the distance is reduced to hold the tube 31, 301. For example, the following dimensions work in the 384 receptacles embodiment of the microplate: Outer diameter d₃ᵢ, d₃₀ᵢ of the tube 31, 301 is 3.95 mm, outer diameter d₃ᵢᵢ, d₃₀ᵢᵢ of the tube 31, 301 is 3.63 mm, the distance between the sidewalls 214 is 4.1 mm or 4.5 mm above the seat rim 212, the distance between the sidewalls 214 is 3.75 mm at the seat rim 212 and the distance between the sidewalls 214 is 3.98 mm below the seat rim 212.

By such configuration, one of the containments 3, 30 can be forwarded top down through the first open end 211 until it is placed inside the receptacle 21. There, it is held by friction or clamped at the seat rim 212. For removing the containment 3, 30 it can be downwardly pushed out of the receptacle 21 via its second open end 213.

The corners of the squared cross section of each of the receptacles 21 forms an indentation as first mating formation. In particular, when used in the second embodiment of the microplate system 10, when being arranged in the respective receptacle 21 the containment 3 is oriented such that the four wing-like protrusions 314 are positioned in the corners of the receptacle 21. Thereby, the containment 3 is secured against a rotational movement of the tube 31. Like this, the cap 32 can be screwed onto or off the tube 31 without requiring to further fix or hold it.

This description and the accompanying drawings that illustrate aspects and embodiments of the present invention should not be taken as limiting—the claims defining the protected invention. In other words, while the invention has been illustrated and described in detail in the drawings and foregoing description, such illustration and description are to be considered illustrative or exemplary and not restrictive. Various mechanical, compositional, structural, electrical, and operational changes may be made without departing from the spirit and scope of this description and the claims. In some instances, well-known circuits, structures and techniques have not been shown in detail in order not to obscure the invention. Thus, it will be understood that changes and modifications may be made by those of ordinary skill within the scope and spirit of the following claims. In particular, the present invention covers further embodiments with any combination of features from different embodiments described above and below.

The disclosure also covers all further features shown in the FIGS. individually although they may not have been described in the afore or following description. Also, single alternatives of the embodiments described in the figures and the description and single alternatives of features thereof can be disclaimed from the subject matter of the invention or from disclosed subject matter. The disclosure comprises subject matter consisting of the features defined in the claims or the exemplary embodiments as well as subject matter comprising said features.

Furthermore, in the claims the word “comprising” does not exclude other elements or steps, and the indefinite article “a” or “an” does not exclude a plurality. A single unit or step may fulfil the functions of several features recited in the claims. The mere fact that certain measures are recited in mutually different dependent claims does not indicate that a combination of these measures cannot be used to advantage. The terms “essentially”, “about”, “approximately” and the like in connection with an attribute or a value particularly also define exactly the attribute or exactly the value, respectively. The term “about” in the context of a given numerate value or range refers to a value or range that is, e.g., within 20%, within 10%, within 5%, or within 2% of the given value or range. Components described as coupled or connected may be electrically or mechanically directly coupled, or they may be indirectly coupled via one or more intermediate components. Any reference signs in the claims should not be construed as limiting the scope.

1. A microplate system comprising:
a microplate; and
a plurality of containments, wherein
the microplate has a length in a range between about 127 mm and about 129 mm, between about 127.3 mm and about 128.3 mm or between 127.26 mm and 128.26 mm, or of about 127.76 mm,
the microplate has a width in a range between about 84 mm and about 86 mm, between about 84.9 mm and about 86 mm or between 84.98 mm and 85.98 mm, or of about 85.48 mm,
the microplate has 384 or 1536 receptacles,
each receptacle of the microplate extends through the microplate such that it has a first open end and a second open end,
each receptacle of the microplate forms a seat to hold one of the plurality of containments,
each of the plurality of containments comprises a cap and a tube; shaped to be held in the seat of one of the receptacles of the microplate,
the plurality of containments and the receptacles of the microplate are shaped such that, in order to be arranged in the microplate, each of the plurality of containments is introducible through the first open end of the one of the receptacles into the one of the receptacles until it is held in the seat of the one of the receptacles, and
the tube and the cap of each of the containments are configured to be multiply connected to each other and disconnected from each other.

2. The microplate system of claim 1, wherein the cap of each containment comprises a first thread structure and the tube of each containment comprises a second thread structure corresponding to the first thread structure of the cap.

3. The microplate system of claim 2, wherein the tube has an open end, the cap has a stem section configured to be provided into the open end of the tube, the first thread structure is arranged at an outer boundary of the stem section of the cap, the second thread structure is arranged at an inner boundary of the tube and the first thread structure engages the second thread structure when the cap is connected to the tube.

4. The microplate system of claim 2, wherein the seat of each receptacle of the microplate has a first mating formation, the tube of each containment has a second mating formation and the first mating formation of the seat of the receptacle cooperates with the second mating formation of the tube when the tube is arranged in the seat of the receptacle such that rotation of the tube relative to the microplate is prevented.

5. The microplate system of claim 4, wherein the second mating formation of the tube comprises a protrusion and the first mating formation of the seat of the receptacle comprises a corresponding indentation configured to receive the protrusion of the second mating formation of the tube when the tube; is arranged in the seat of the receptacle.

6. The microplate system of claim 1, wherein the cap of each of the containments comprises a first press-fit structure and the tube; of each of the containments comprises a second press-fit structure corresponding to the first press-fit structure of the cap.

7. The microplate system of claim 6, wherein the first press-fit structure of the cap is pressed against the second press-fit structure of the tube, when the cap and the tube are connected.

8. The microplate system of claim 6, wherein the first press-fit structure of the cap comprises a sealing bulge at an outer circumference of the cap.

9. The microplate system of claim 8, wherein the cap comprises a snap cavity with an opening accessible when the cap is connected to the tube.

10. The microplate of claim 1, wherein the cap of each of the containments is made of a comparably elastically deformable material and the tube of each of the containments is made of a comparably rigid material.

11. The microplate system of claim 10, wherein the cap has an outer diameter, the tube has an inner diameter and the inner diameter of the tube is smaller than the outer diameter of the cap.

12. The microplate system of claim 10, wherein the tube has an open end and the cap is configured to be at least partially compressed when being forwarded into the tube through the open end of the tube.

13. The microplate system of claim 6, wherein the tube has an inner periphery equipped with a protrusion.

14. The microplate system of claim 1, wherein the plurality of containments and the receptacles of the microplate are shaped such that, in order to be removed from the microplate, each of the plurality of containments is pushable through the microplate out of the seat of the one of the receptacles through the second open end of the one of the receptacles.

15. A containment
configured to be held in a seat of one of 384 or 1536 receptacles of a microplate which has a length in a range between about 127 mm and about 129 mm, between about 127.3 mm and about 128.3 mm or between 127.26 mm and 128.26 mm, or of about 127.76 mm, and a width in a range between about 84 mm and about 86 mm, between about 84.9 mm and about 86 mm or between 84.98 mm and 85.98 mm, or of about mm, wherein each receptacle extends through the microplate such that it has a first open end and a second open end, and forms the seat, and
shaped such that, in order to be arranged in the microplate, the containment is introducible through the first open end of the one of the receptacles until it is held in the seat of the one of the receptacles and, in order to be removed from the microplate, is pushable through the microplate out of the seat of the one of the receptacles through the second open end of the one of the receptacles,
wherein the containment comprises
a tube and a cap,
wherein the tube is shaped to be held in the seat, and
the tube and the cap are configured to be multiply connected to and disconnected from each other.
